(19) United States
(12) Patent Application Publication
(10) Pub. No.: US 2013/0291976 A1
(43) Pub. Date: Nov. 7, 2013

(54) QUICK-RELEASE COUPLING

(71) Applicant: Chia-Chun Chang, Lungshou Village (TW)

(72) Inventor: Chia-Chun Chang, Lungshou Village (TW)

(73) Assignee: SUN-WONDER INDUSTRIAL CO., LTD., Lungshou Village (TW)

(21) Appl. No.: 13/463,787

(22) Filed: May 3, 2012

(51) Int. Cl. F16L 37/28

(52) U.S. Cl. 137/798

(57) ABSTRACT

A quick-release coupling includes a socket defining a first passage in a connection port thereof, a locking member mounted in a front end of the socket and adapted for locking an inserted external male mating connector, an air valve control device mounted in a rear end of the socket, and a leak-proof device, which includes a stopper mounted in the front end of the socket and defining an axially extending second passage and a transversely extending third passage and a plurality of gasket rings mounted around the stopper at two opposite lateral sides of the third passage for allowing fluid communication between the first passage and the second and third passages or blocking the first passage from the second and third passage after movement of the stopper relative to the socket between two positions.

### BACKGROUND OF THE INVENTION

1. Field of the Invention

The present invention relates to coupling devices and more particularly, to a quick-release coupling for refrigerant cycle system, which prevents refrigerant leak.

2. Description of the Related Art

When removing a mating male connector from a quick-release coupling of a refrigerant cycle system, a pressure-discharge process is simultaneously performed. Thus, a residual gas will be ejected out of the mating male connector and the quick-release coupling upon removal of the mating connector from the quick-release coupling. A quick-release coupling for use in a refrigerant cycle system is adapted for the extraction of refrigerant. According to conventional designs, when connecting the mating male connector to the quick-release coupling, the passage between the quick-release coupling/mating male connector and the refrigerant cycle system is blocked. When the user pushes the pusher pin of the quick-release coupling, the sealer of the mating male connector is opened, allowing fluid communication between the mating male connector, the quick-release coupling and the refrigerant cycle system. The passage is opened when the pusher pin of the quick-release coupling is operated to move the sealer of the mating male connector. After a refrigerant filling/cycling operation, the pusher pin is moved back, and the passage of the quick-release coupling and the passage of the mating male connector are blocked. At this time, the quick-release coupling and the mating male connector still have residual refrigerant left therein. The residual refrigerant will leak out of the quick-release coupling and the mating male connector after removal of the mating male connector from the quick-release coupling, causing environmental pollution and making harm to the user's health.

### SUMMARY OF THE INVENTION

The present invention has been accomplished under the circumstances in view. It is one object of the present invention to provide a quick-release coupling, which provides a leak-proof device in the front end thereof that allows complete extraction of residual refrigerant before removal of the connected mating male connector, and automatically blocks the passage to prevent refrigerant leak and environmental pollution after removal of the connected mating male connector.

To achieve this and other objects of the present invention, a quick-release coupling comprises a socket that defines a first passage in a connection port thereof, a locking member mounted in the front end of the socket and adapted for locking an inserted external male mating connector, an air valve control device mounted in the rear end of the socket, and a leak-proof device, which comprises a stopper mounted in the front end of the socket and defining an axially extending second passage and a transversely extending third passage and a plurality of gasket rings mounted around the stopper at two opposite lateral sides of the third passage for allowing fluid communication between the first passage and the second and third passages or blocking the first passage from the second and third passage after movement of the stopper relative to the socket between two positions.

### BRIEF DESCRIPTION OF THE DRAWINGS

FIG. 1 is an elevational view of a quick-release coupling in accordance with the present invention.

FIG. 2 is an elevational view of a part of the quick-release coupling in accordance with the present invention.

FIG. 3 is a sectional side view of the quick-release coupling in accordance with the present invention.

FIG. 4 is a schematic drawing illustrating an operation status of the quick-release coupling in accordance with the present invention (I).

FIG. 5 is a schematic drawing illustrating an operation status of the quick-release coupling in accordance with the present invention (II).

FIG. 6 is a schematic drawing illustrating an operation status of the quick-release coupling in accordance with the present invention (III).

### DETAILED DESCRIPTION OF THE PREFERRED EMBODIMENT

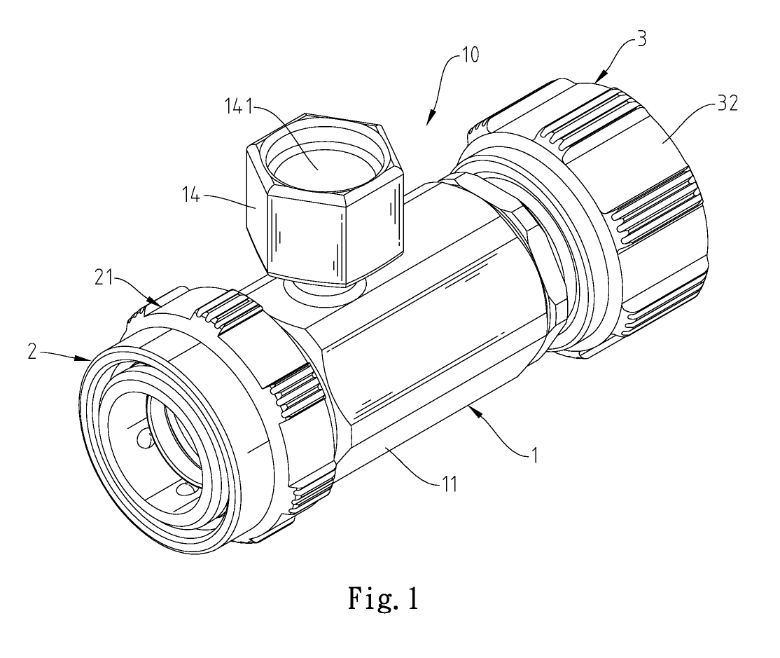

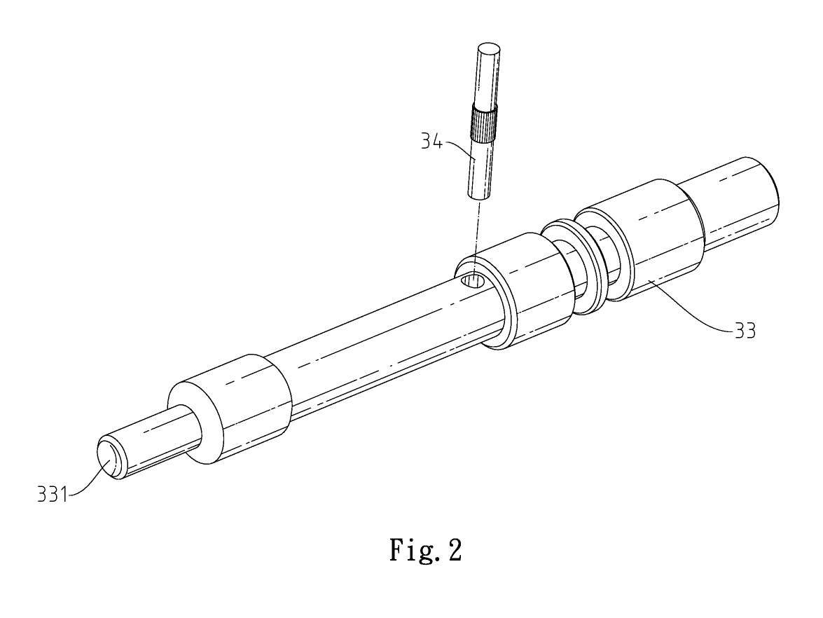

Referring to FIGS. 1-4, a quick-release coupling 10 in accordance with the present invention is shown comprising a socket 1, a locking member 2, an air valve control device 3, and a leak-proof device 5.

The socket 1 comprises a socket body 11 defining opposing front end 12 and rear end 13 in communication with each other, an inner thread 131 formed in the rear end 13 of the socket body 11, a connection port 14 connected to a refrigerant pump (not shown) and defining therein a first passage 141 in communication with the inside space of the socket body 11, and a plurality of radial holes 121 disposed around the periphery of the front end 12 of the socket body 11.

The locking member 2 comprises a sliding chuck 21, a first spring member 22, and a plurality of rolling balls 23. The rolling balls 23 are respectively rotatably mounted in the radial holes 121 of the socket 1. The sliding chuck 21 is mounted around the front end 12 of the socket body 11 of the socket 1, having an engagement portion 211 protruded from the inside wall thereof. The first spring member 22 is mounted on the front end 12 of the socket body 11 of the socket 1 and stopped between the engagement portion 211 and a part of the socket body 11 to impart a forward pressure to the engagement portion 211 against the rolling balls 23 in the radial holes 121 of the socket 1.

The air valve control device 3 comprises a plug 31, which comprises a first outer thread 311 extending around the front end thereof and threaded into the inner thread 131 of the socket body 11 of the socket 1 and a second outer thread 312 extending around the rear end thereof and disposed outside the socket 1, a grip 32, which comprises an inner thread 321 threaded onto the outer thread 312 of the plug 31, a pusher pin 33, which is axially movably inserted through the plug 31 into the inside of the socket body 11 of the socket 1 and affixed to the grip 32 by a fastening member 7 and having a front tip 331 suspending in the front end 12 of the socket body 11, and a stop pin 34 transversely fastened to the pusher pin 33 and stoppable at the front side of the plug 31 inside the socket body 11 of the socket 1.

The leak-proof device 5 comprises a stopper 51 axially movably mounted inside the front end 12 of the socket body 11 of the socket 1 and defining opposing front push end 511 and rear stop end 512, a second passage 513 axially extending through the front push end 511 and rear stop end 512 of the stopper 51 for receiving the pusher pin 33, a third passage 514 transversely extending through the front push end 511 across the second passage 513, a second spring member 52 stopped between the stopper 51 and the plug 31, and a plurality of gasket rings 53 mounted around the front push end 511 of the stopper 51 at two opposite lateral sides relative to the third passage 514.

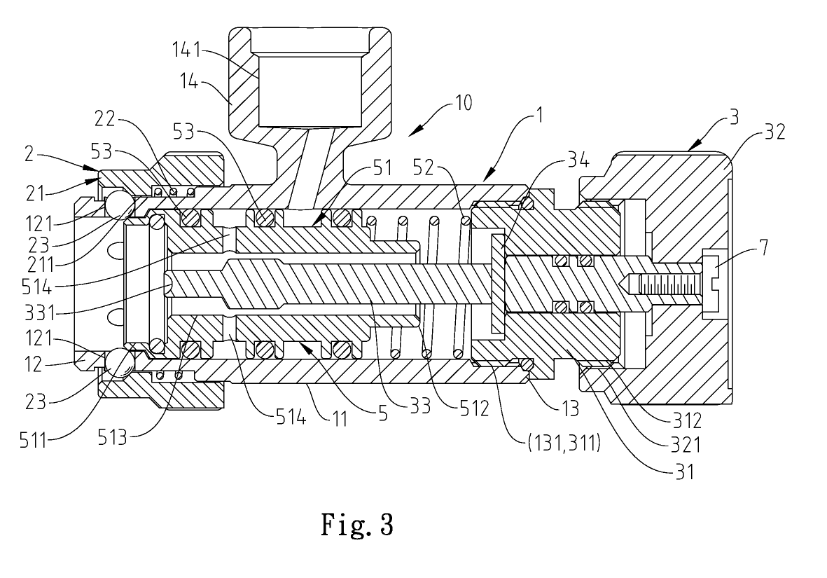

Referring to FIGS. 3-6, before application of the quick-release coupling 10, as shown in FIG. 3, the stopper 51 of the leak-proof device 5 is forced by the second spring member 52 into engagement with the inside wall of the front end 12 of the socket body 11 of the socket 1. When using the quick-release coupling 10, rotate the grip 32 to move the pusher pin 33 in direction away from the socket body 11 of the socket 1 to the position where the stop pin 34 is stopped at the front side of the plug 31 inside the socket body 11 of the socket 1. At this time, the third passage 514 of the stopper 51 is blocked from the first passage 141 by one gasket ring 53.

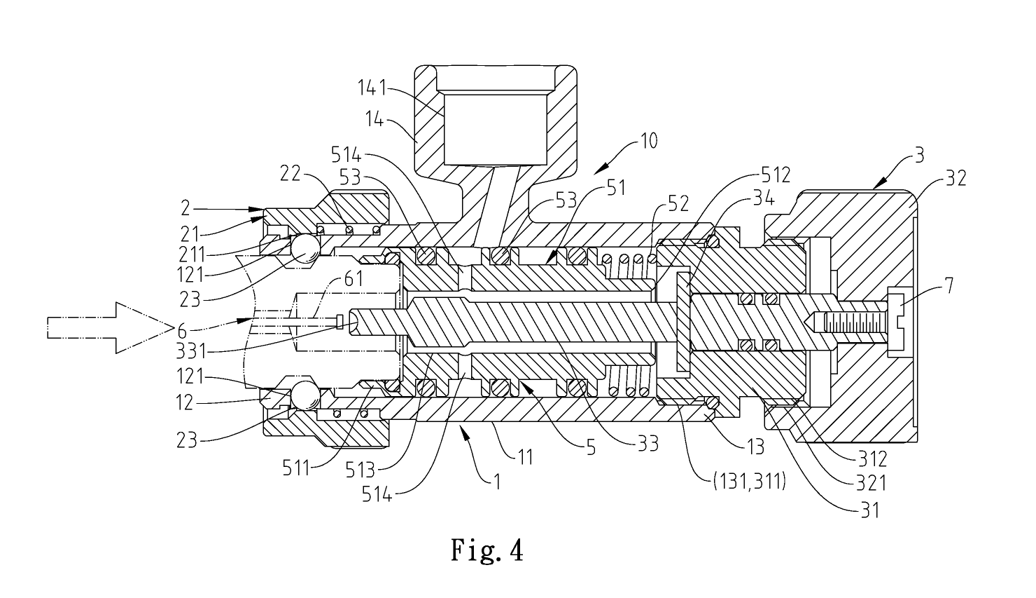

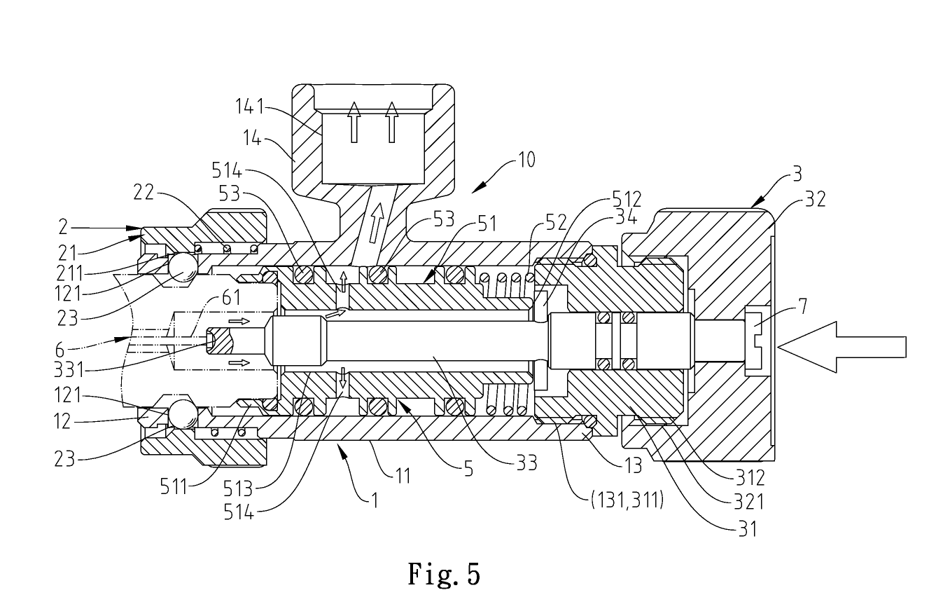

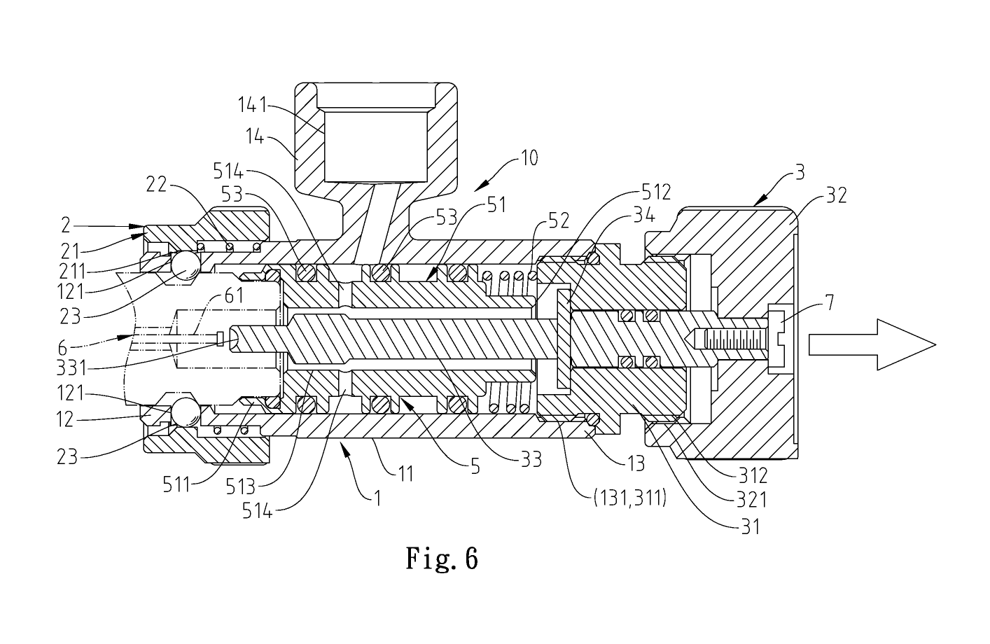

Thereafter, insert a mating male connector 6 into the front end 12 of the socket body 11 of the socket 1, as shown in FIG. 4. After insertion of the mating male connector 6 into the front end 12 of the socket body 11 of the socket 1, the mating male connector 6 is firmly secured to the socket body 11 by the sliding chuck 21 and rolling balls 23 of the locking member 2 and the pusher pin 33 is kept away from an air valve pin 61 of the mating male connector 6. Further, inserting the mating male connector 6 into the front end 12 of the socket body 11 of the socket 1 will push the front push end 511 of the stopper 51, moving the stopper 51 toward the rear end 13 of the socket body 11 to the position where the third passage 514 of the stopper 51 is kept in alignment and fluid communication with the first passage 141. Referring to FIG. 5, after the mating male connector 6 is locked to the front end 12 of the socket body 11, rotate the grip 32 to move the pusher pin 33 in direction toward the socket body 11 of the socket 1, stopping the stop pin 34 against the rear stop end 512 of the stopper 51. At this time, the front tip 331 of the pusher pin 33 pushed the air valve pin 61 of the mating male connector 6, and the refrigerant pump is started to pump refrigerant into the second passage 513 and then the first passage 141 toward the outside of the connection port 14. Referring to FIG. 6, when going to remove the mating male connector 6 from the quick-release coupling 10, rotate the grip 32 to move the pusher pin 33 in direction away from the socket body 11 to the position where the stop pin 34 is stopped at the front side of the plug 31 inside the socket body 11 of the socket 1. At this time, the front tip 331 of the pusher pin 33 is kept away from the air valve pin 61 of the mating male connector 6, and the refrigerant is stopped from flowing out of the mating male connector 6, however, the first passage 141 is still kept in communication with the second passage 513 and the third passage 514, allowing the refrigerant pump to continuously pump residual refrigerant in the mating male connector 6 and the quick-release coupling 10 toward the outside of the connection port 14. Therefore, removal of the mating male connector 6 from the quick-release coupling 10 does not cause any refrigerant leak. As the quick-release coupling 10 and the mating male connector 6 are not in a high pressure status at this time, the mating male connector 6 can easily be removed from the quick-release coupling 10, preventing gushing refrigerant.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A quick-release coupling, comprising:
a socket comprising a socket body defining opposing front end and rear end in communication with each other, a connection port defining therein a first passage in communication with an inside space of said socket body, and a plurality of radial holes disposed around a periphery of said front end of said socket body;
a locking member comprising a sliding chuck mounted around said front end of said socket body of said socket, said sliding chuck comprising an engagement portion protruding from an inside wall thereof, a plurality of rolling balls respectively rotatably mounted in said radial holes of said socket, and a first spring member mounted on said front end of said socket body of said socket and stopped between said engagement portion and a portion of said socket body to impart a forward pressure to said engagement portion of said sliding chuck against said rolling balls in said radial holes of said socket;
an air valve control device comprising a plug mounted in a rear end of said socket body, a grip coupled to said plug, and a pusher pin axially movably inserted through said plug into the inside of said socket body and movable axially by said grip relative to said plug and said socket body, said pusher pin comprising a front tip suspending in the front end of said socket body, a neck suspended in said socket body adjacent to the rear end of said socket body and a collar connected between said front tip and said neck; and
a leak-proof device comprising a stopper axially movably mounted inside the front end of said socket body and defining opposing a front push end and a rear stop end, a second passage axially extending through said front push end and said rear stop end for receiving said pusher pin, a third passage transversely extending through said front push end across said second passage and a second spring member stopped between said stopper and said plug, said stopper being axially movable relative to said socket body between a first position where said first passage is blocked from said second passage and said third passage and a second position where said first passage is in fluid communication with said second passage and said third passage.

2. The quick-release coupling as claimed in claim 1, wherein said leak-proof device further comprises a plurality of gasket rings mounted around said front push end of said stopper at two opposite lateral sides relative to said third passage.

3. The quick-release coupling as claimed in claim 1, wherein said air valve control device further comprises a stop pin transversely fastened to said pusher pin and stoppable at a front side of said plug inside said socket body.

4. The quick-release coupling as claimed in claim 1, wherein said plug of said air valve control device comprises a first outer thread extending around a front end thereof and a second outer thread extending around a rear end thereof and disposed outside said socket; said socket body of said socket comprises an inner thread threaded onto said first outer thread of said plug; and said grip comprises an inner thread threaded onto said second outer thread of said plug.
